(19) United States
(12) Patent Application Publication
(10) Pub. No.: US 2020/0339487 A1
(43) Pub. Date: Oct. 29, 2020

(54) Cannabinoid Compositions Having Improved Bioactivity and Methods Thereof

(71) Applicant: Reno R. Rolle, Ojai, CA (US)

(72) Inventor: Reno R. Rolle, Ojai, CA (US)

(21) Appl. No.: 16/858,690

(22) Filed: Apr. 26, 2020

Related U.S. Application Data
(60) Provisional application No. 62/838,508, filed on Apr. 25, 2019.

(51) Int. Cl. C07B 37/06; B01J 31/02; A23L 33/105; A23L 29/00; A23L 33/135; A23L 33/175; A23L 2/52; A23L 2/39

(52) U.S. Cl. CPC C07B 37/06; B01J 31/0271; A23L 33/105; A23L 29/06; A23L 33/135; A23V 2002/00; A23L 2/52; A23L 2/39; B01J 2531/002; B01J 2231/005; A23L 33/175

(57) ABSTRACT

A composition for the activation (decarboxylation) and improved bioavailability of acid-form cannabinoids is provided. The composition includes dried Cannabis sativa L, such as dried hemp flower, dried food powder, and at least one catalyst, selected from dried citrus juice, lemon juice or composition thereof. The dried Cannabis sativa L is combined with the dried food powder including at least one catalyst for cold decarboxylation and improved bioavailability of cannabinoids. Preferably the catalyst becomes immediately effective when the composition is mixed into an aqueous solution for consumption. The composition is also endowed with a cytochrome p450 enzyme inhibitor in the form of dried food powder having an ascorbic acid content, or other enzyme inhibitor, in sufficient amount to inhibit hepatic enzymes in vivo and improve the bio-effects of the cannabinoids.

### FIELD OF THE INVENTION

The present invention relates to compositions and methods for decarboxylation and improving bioavailability of raw whole plant Cannabis sativa L. More particularly, the invention uses food ingredients and water for decarboxylation and improving bioavailability of cannabinoids.

### BACKGROUND OF THE INVENTION

The pharmacological and therapeutic properties of cannabinoids are undergoing substantial discovery over the last few decades and are subject to a growing amount of scientific research.

Cannabinoids are known in the prior art for use in therapeutic treatment of disease, disorder or various medical conditions. Cannabinoids includes analgesic, anti-inflammatory, anticancer, antibiotic, anti-anxiety, and anti-oxidant properties.

Cannabinoids can influence cannabinoid receptors in humans and other mammals. Cannabinoid receptors (CB1 and CB2) belong to G-protein coupled receptors (GPCRs). In general there are three sources of cannabinoids. Endocannabinoids are produced naturally in the body. Phytocannabinoids are produced in plants. One notable source of phytocannabinoids is Cannabis sativa L. Synthetic cannabinoids are produced in a laboratory environment.

Cannabis sativa L includes both marijuana and hemp. Cannabinoids are found in Cannabis sativa L. Among these compounds, Δ⁹-tetrahydrocannabinol (Δ⁹-THC), cannabinol (CBN), and cannabinodiol (CBDL) are known to be psychoactive. Other cannabinoids such as cannabidiol (CBD), which is a non-psychoactive compound, exert their physiological effects through a variety of receptors including cannabinoid receptors found in the cells. The term THC as used herein denotes all THC compounds and isoforms including Δ⁹ and Δ⁸ THC.

Natural Cannabinoids are found in an acid (non-decarboxylated) form. Cannabinoids can be converted into a non-acid) (decarboxylated form) by a process referred to as decarboxylation. Decarboxylation is a chemical reaction that removes the carboxyl group from a Cannabinoid compound. In the case of cannabinoids, decarboxylation involves removing the carboxyl group from the cannabinoid compounds. In one example in Cannabis, the non-psychoactive Δ9-THC-A can be converted to psychoactive Δ9-THC by decarboxylation. Decarboxylation improves bio-effect of some Cannabis (activates the cannabinoids), however because decarboxylation often relies on heat, some of the other beneficial plant components are degraded, destroyed, or volatilized.

Many people are reluctant to use Cannabinoid (either as a medicine or natural health product). Cannabinoid delivery in humans has traditionally been associated with smoking or heating (i.e. vaping) the flowers of Cannabis sativa L. Smoking has several drawbacks however. Smoke may contain small quantities of carcinogenic compounds. Some users simply do not like smoking. Others may have lung conditions which makes smoking very unpleasant. Therefore, people may be more accepting of Cannabinoid if it is in a form that is more conventional (i.e. as food, tablet form, or other conventional forms of medicine). In order to produce conventional forms of Cannabinoids for use as a medicine or natural health product, the cannabinoids in the product is often decarboxylated. Decarboxylation converts cannabinoids from the naturally occurring acid form of the cannabinoid molecule to a non-acid form that is typically more bio-available and bio-effective.

### SUMMARY OF THE INVENTION

Decarboxylation is a chemical reaction that involves detaching a carboxyl group, or acid, from a molecule. The carboxyl group (COOH) includes a carbon atom bonded to an oxygen atom (CO) and a hydroxyl group (OH). Removal of the carboxyl group releases carbon dioxide. This readily occurs through exposure to heat or light. This also occurs over time with little light or heat exposure. There are also catalysts that rapidly enable the removal of the carboxyl group from the cannabinoid molecule. What is desired by the present invention is to present natural, yet bio-available and bio active forms of cannabinoids for oral consumption.

The addition of water to acid-form cannabinoids may create an environment where the water added to the carboxyl group in the presence of a proton in the position α to the carboxyl can catalyze the C—C cleavage, producing carbonic acid that rapidly decomposes into CO₂. In the presence of water, this reaction is less likely to reverse, thus, the rate of the reaction is not inhibited by extensive reversal of the reaction. This is a catalyst-enhanced hydrolysis reaction.

In one embodiment of the invention, the catalyst is a proton donor such as a Lewis Acid. Cations of metals, ions, carbocations, and pentahalides are examples of Lewis Acids.

Mg²⁺ and Li⁺ or other common cations of metals can form coordination compounds in water, where water acts as the ligand. These aquo complexes can accept electron pairs, act as Lewis Acids, and rapidly decarboxylate cannabinoids, including CBD-A. These and other cations are commonly found in natural foods including fruits, berries and nuts.

In another embodiment, the proton donor is an amino group, derived from a plant based L-amino acid having a central a carbon that is a chiral carbon. In another embodiment, the method of the invention includes providing an amino acid is selected from the group consisting of one or more of the following Amino Acids: Arginine, Carnitine, Glutamine, Methionine, Ornithine, Taurine, and combinations thereof to catalyze a decarboxylation reaction with at least one cannabinoid when the composition is mixed in an aqueous solution with dry Cannabis material.

In another embodiment, the use of β-keto acid type mechanism for the decarboxylation of cannabinoids is enabled.

Other ways to improve bioactivity of cannabinoids includes orally consuming a cytochrome p-450 enzyme inhibitor to inhibit first pass metabolism of the orally consumed cannabinoids.

Ascorbic acid is found in many fruits, particularly citrus and berries such as blueberry powder, or goji berry powder. Ascorbic acid is an example of a cytochrome p-450 enzyme inhibitor.

The present invention includes formulations including dry or powdered Cannabis sativa L. combined with dried cytochrome P-450 inhibitors, and a metal aquo complex catalyst to decarboxylate the cannabinoids when water is added. These formulations are particularly useful when delivered in a beverage powder form intended to be re-constituted in an aqueous solution or water.

Therefore, there is a need to develop an efficient active form of Cannabis composition without heating for decarboxylation to preserve the volatile terpenes and other components of the Cannabis plant. Cannabis is Cannabis sativa l., which includes both Hemp and Marijuana.

Provided herein are pharmaceutical compositions combining raw Cannabis sativa L or dried hemp with dried food powder without heating to activate cannabinoids for bioavailability.

In one aspect of the present invention provides a composition for decarboxylation and bioavailability of cannabinoids comprising dried Cannabis sativa L, dried food powder, and at least one catalyst, selected from dried citrus juice, lemon juice or composition thereof.

In one aspect of the present invention, the dried food powder is an excipient. The excipient includes a blend food ingredients including Barley Grass Juice, Nettle Leaf, Nopal Cactus, Spinach, Kale, Cabbage, Parsley, Spirulina, Chlorella, Maca Root, Mushroom Blend, Super Sprouts, Sweet Mesquite, Fine Vanilla Bean, Lucuma Fruit, Goji Berry, Hawthorn Berry, Blackberry, Pomegranate, Blueberry, Acai, Strawberry, Tart Cherry, Cranberry, Red Raspberry, Vermont Maple Syrup, Lactobacillus sporogenes, Digestive Enzymes, Himalayan Pink Crystal Salt, Kelp, which are each sources of cytochrome enzyme inhibitors, acids including ascorbic acid, various amino group molecules, and amino acids.

The excipient blend, unlike many excipients, provides numerous trace terpenes, nutrients, anti-oxidants, flavonoids, amino acids, enzymes, enzyme inhibitors, and other compounds. It is observed that this excipient cooperates with the cannabinoids (particularly acid form cannabinoids), and the dried citrus powder, to provide a noticeably improved bio-effect in four out of five consumers, compared to the consumption of cannabinoids and citrus alone. Thus, the excipient exhibits bio-effects and benefits for a number of biochemical reasons and cooperates nicely with the combination of cannabinoids and catalyst.

In one aspect of the present invention provides a pharmaceutical composition comprising dried Cannabis sativa L, dried food powder, and at least one catalyst in selected ratios by weight, wherein the composition exhibits an increased therapeutic potency and bioavailability of cannabinoids. The catalyst catalyzes hydrolysis of acid form cannabinoids including any selected from the following: Cannabidiolic acid (CBD-A), Tetrahydrocannabinolic Acid (THC-A), Cannabidivarinic acid (CBDV-A), Cannabichromenic acid (CBC-A), Cannabichromevarinic acid (CBCV-A), Cannabielsoin acid A (CBEA-A), Cannabielsoic acid B (CBEA-B), Cannabinodivarin (CBVD), Cannabinolic acid (CBNA), Cannabigerolic acid (CBGA), Cannabigerovarinic acid (CBGVA), Delta-9-tetrahydrocannabivarinic acid (THCVA) and combinations thereof.

In one aspect of the present invention, a ratio of dried food powder to dried Cannabis sativa L in the composition of the present invention ranges from 100:1 to 25:1. The ratio of combined cannabinoids is 400:1 to 75:1. It can be appreciated that it is preferred to use dry plant material for the Cannabis and the cannabinoids contained therein. While plants can be bred and engineered to express desired cannabinoid profiles, it can also be appreciated that there may be a desirable circumstance to bolster the formulation of the present invention with either acid form, or non-acid forms of purified cannabinoids to achieve the ratios expressed herein.

In one aspect, the at least one catalyst in the composition of the present invention for bioavailability is dried citrus juice. Dried citrus, citric acid, and concentrated citrus in dry form has the ability to inhibit hepatic enzymes to improve bioavailability and bio effect of cannabinoids. Studies indicate that four out of five subjects observe noticeably improved bio-effects from the dried food powder including both cannabinoids, and dried citrus. These effects range from pain management to a general sense of well-being. Citric acid can also catalyze hydrolysis to decarboxilated acid form cannabinoids.

In one aspect, the at least one catalyst in the composition of the present invention for bioavailability is preferably lemon juice, but can be another dried citrus juice, or acetic acid (dried vinegar) having a 5% acidity.

In one aspect of the present invention, the catalyst is 0.01-1% of the dried food powder on a w:w basis.

In another aspect of the present invention includes a method for rendering cannabinoids bio-available when consumed orally without heating by combining raw Cannabis with the dried food powder.

In another aspect of the present invention includes raw (harvested or fresh) dried hemp with the dried food powder.

In another aspect of the present invention provides a method for activation (decarboxylation) and bioavailability of cannabinoids by combining dried hemp or marijuana with the whole food ingredients.

In another aspect of the invention, the composition includes dried food powder and hemp in ratio of 55.1 (55 parts of dried food powder and 1 part of dried hemp bio mass) on a weight to weight. The combination of the dried hemp in the dried food powder is for activation (decarboxylation) of the cannabinoids.

Marijuana can be substituted for the hemp in accordance with the present invention. In an alternate embodiment both marijuana and hemp are combined to achieve the desired cannabinoid composition and ratios. It can be further appreciated that select Cannabis biomass can be selected and blended to achieve a desirable cannabinoid mix and terpene profile.

The present invention is particularly useful for a rapidly constituted beverage such as a juice smoothie, or fruit infusion, by adding water to the dried powder formulation.

In another aspect of the present invention provides a fresh juice beverage. Cannabinoids are activated in a cold press the full hemp bio mass beverage by and adding the hemp biomass with other plant based juices or powders. The juice includes an enzymes, amino acids, proteins and other catalysts to enable decarboxylation of the cannabinoids in the hemp juice. Juice from lemons and other citrus can be added to function as both a hydrolysis catalyst, and as a p450 enzyme inhibitor in vivo.

It will be understood that certain ingredients can be added to the compositions described herein without materially affecting the basic and novel properties of the compositions described herein. For example, the compositions can include undisclosed and/or unclaimed ingredients that do not materially affect the basic and novel properties of the compositions described herein, therapeutic or otherwise. Examples of such ingredients include flavorings and sweeteners that provide a more pleasant taste and/or odor, but do not materially affecting the desired properties, therapeutic or otherwise, of the compositions described herein.

Other variations, embodiments and features of the present disclosure will become evident from the following detailed description, abstract and claims.

### DETAILED DESCRIPTION

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art. Further the usefulness of the present invention in improving bioavailability is clear from subjective testing and other data, however the exact mechanism of action is not perfectly clear. There may be a number of mechanisms of action in play that enable a dry mixture to activate cannabinoids after the mixture is added to an aqueous solution.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

The term “pharmaceutical composition or composition” includes the compositions described herein and any additional components that are desired for use of the composition to a user or for use of the composition by a user.

The term “treating” or “treatments” or “prevention” as used herein can include any of the following: alleviating, reducing, improving, mitigating, or eliminating a disease, disorder or medical condition.

As used herein, “therapeutically effective amount” refers to administration of an amount of a given compound, to a subject in need thereof that achieves the desired therapeutic effect.

The term “subject” as used herein refers to a mammal, preferably a human.

The present invention provides a novel cannabinoid composition for creation of food or beverage products. The invention relies upon the cold activation of cannabinoids and methods to improve bioavailability of the cannabinoids without heating.

In an embodiment, the composition is prepared by combining/blending dried Cannabis Sativa L into dried food powder to enable later decarboxylation cannabinoids when the composition is mixed with an aqueous solution. An advantage of cold processing is that volatile plant components including terpenes, aromatic components, flavonoids, nutrients and other compounds are preserved.

In an embodiment, the composition further comprises at least one catalyst for bioavailability of cannabinoids. The catalyst is added in a concentration to be effective in catalyzing a decarboxylation reaction in at least one cannabinoid when the formulation is mixed in water or any aqueous or polar solution. Preferably the catalyst is a nutritive component such as a food ingredient, or compound contained in a food ingredient. Mixing using a blender, food processor, air pulsed mixing, magnetic paddle mixer, are considered appropriate for mixing the present invention with an aqueous solution for a duration that enables decarboxylation of at least a portion of the acid form cannabinoids in the cannabinoid composition.

In an embodiment, the composition provides enhanced therapeutic potency of treating/preventing/ameliorating one or more disease(s) or condition(s).

In another embodiment, the dried food powder is a superfood such as a (BõKU™) dried food powder. Ideally the food powder includes various ingredients that provide essential nutrients for a body need for the day, all in one place. In this embodiment, 55 organic food ingredients are included to serve important physiological functions and that taste great together.

The food ingredients preferably include the world's most powerful and potent plants and are formulated precisely for the human mind, body, and spirit. The dried food powder comprises highly concentrated nutrition, an array of amino acids, anti-oxidants, and catalysts in sufficient concentration and availability to help cleave carbon molecule bonds and effectuate decarboxylation in acid form cannabinoids when combined in an aqueous solution such as water, cow milk, seed milk, nut milk, smoothie or juice. This decarboxylation is accomplished without adding heat so that the nutritive food ingredients are preserved and not degraded significantly.

The dried food powder contains food ingredients including but not limited to Barley Grass Juice, Nettle Leaf, Nopal Cactus, Spinach, Kale, Cabbage, Parsley, Spirulina, Chlorella, Maca Root, Mushroom Blend, Super Sprouts, Sweet Mesquite, Fine Vanilla Bean, Lucuma Fruit, Goji Berry, Hawthorn Berry, Blackberry, Pomegranate, Blueberry, Acai, Strawberry, Tart Cherry, Cranberry, Red Raspberry, Vermont Maple Syrup, Lactobacillus sporogenes, Digestive Enzymes including bioactive amino acids, Himalayan Pink Crystal Salt, Kelp, and combinations thereof.

In an embodiment, the composition of the present invention comprising dried food powder (i.e. whole food ingredients), Cannabis sativa L and at least one catalyst in selected ratios by weight, wherein the composition exhibits an increased therapeutic potency and bioavailability of cannabinoids.

In an embodiment, the composition of the present invention is prepared for rendering cannabinoids bio available when consumed orally without heating by combining raw Cannabis with the dried food powder.

In an embodiment, the Cannabis is combined with other synergistic foods to trigger the chemical reaction similar in effect to decarboxylation, which renders the beneficial cannabinoids active and bioavailable.

In an embodiment, a ratio of dried food powder to dried Cannabis sativa L in the composition of the present invention ranges from 100:1 to 25:1.

In another embodiment, the at least one catalyst in the composition of the present invention for bioavailability is dried citrus juice.

In another embodiment, the at least one catalyst in the composition of the present invention for bioavailability is preferably lemon juice, but can be another dried citrus juice.

In another embodiment, the catalyst is 0.01-1% of the dried food powder on a w:w basis.

Further in some embodiments, the catalyst may be used in the composition of the present invention is dried juice or power is selected from a group comprising of Citric Acid, Ascorbic Acid, Citrus Essential Oils, Orange Essential Oil, Tangerine Essential Oil, Grapefruit Essential Oil, Lime Essential Oil, Lemon Essential Oil or combinations thereof.

In another embodiment, the composition of the present invention includes raw (harvested or fresh) dried and blended hemp with the dried food powder.

In another embodiment, the composition of the present invention is used for activation (decarboxylation) and bioavailability of cannabinoids by combining dried hemp with the dried food powder.

In another embodiment, a ratio of dried food powder to dried hemp in the composition of the present invention is 55.1 (55 parts dried food powder and 1 part dried hemp bio mass) on a weight to weight. The combination of the dried hemp in the dried food powder is for activation (decarboxylation) of the cannabinoids.

In another embodiment, the present invention provides cannabinoids activation by cold press the full hemp bio mass and adding the hemp biomass with other plant based juices. The juice includes an enzyme found for example in lemons and other citrus.

In another embodiment of the present invention, the composition includes fresh squeezed juice. Importantly in a 1 oz shot of pure fresh hemp juice ¼ to ½ tsp of lemon juice is added. This amplifies the bio-effects of the hemp juice shot. The hemp juice shot has a predominance of CBD in its acid form.

In another embodiment of the present invention, the composition includes the lemon juice that can be substituted by any citrus juice, or perhaps natural vinegar, particularly pro-biotic apple cider vinegar. The vinegar can be presented in a dehydrated and powdered form and mixed with the excipient. The catalyst is adjusted in strength and concentration to optimize the decarboxylation of the cannabinoids upon mixing the product into an aqueous beverage or upon ingestion with food.

In another embodiment of the present invention, the composition include includes bioactive turmeric extract, and/or ginger extract. The bioactive extract can be a juice or a concentrate in dry form. In an alternate embodiment, dried mushroom powder is added.

In another embodiment of the present invention, the composition includes a dried food powder that is sold and re-constituted by the consumer by mixing into a juice, smoothie, milk or water.

In another embodiment of the present invention, the composition is prepared as edibles including but not limited to cakes, cookies, and candies.

In another embodiment of the present invention, the composition is in the form of a dried powder using dried citrus juice in a 1/200 to 1/25 ratio of dried citrus juice to dried Cannabis juice on a w:w basis.

In another embodiment, raw Cannabis is combined with specific and partner foods that contain the desired phyto-compounds. Cannabis and foods are kept raw (below 118 degrees). The combined food product can be dry or wet, eaten or drank. Raw Cannabis is beneficial for use with the present invention because heating Cannabis releases volatile terpenes, cannabinoids and other plant components. The present invention seeks to preserve these until the product is consumed. In this way the benefit of the whole plant is preserved, while simultaneously enabling the activation of particular cannabinoids such as THC, CBD and others.

In another embodiment of the invention, the composition as described herein can be used to manipulate the endocannabinoid system into effecting an enhanced decrease in pain, as well as an enhanced sense of health, including an ability to more successfully overcome cancer.

Thus, the composition described herein are useful for the treatment and prevention of a wide range of diseases, disorders or medical conditions, including, for example, including without limitation nausea, vomiting, cancer, muscle spasticity, pain, anorexia, AIDS, epilepsy, glaucoma, Chrohn's disease, inflammatory bowel disease, multiple sclerosis, Amylotrophic Lateral Sclerosis (ALS), muscular dystrophy, bronchial asthma, post-traumatic stress disorder, mood disorders, cough and migraine headaches. Person skilled in the art will recognize that the embodiments described herein may be used to treat many diseases, disorders or medical conditions that respond favorably thereto. Further, the composition is non-toxic in nature and may be used in conjunction with traditional medical, pharmaceutical and nutraceutical applications.

The embodiments described above demonstrate an improved efficacy that is unexpected compared to utilizing the same dose of the same active source of cannabinoid concentrate.

### Methods

The present invention includes a method for cold decarboxylation of acid form cannabinoids. The method includes providing dried Cannabis sativa L. biomass having acid form cannabinoids such as THC-A and CBD-A.

Next, the method includes forming a cannabinoid composition by mixing a catalyst with the Cannabis sativa L. biomass in an aqueous solution at a temperature of less than 176° F. to cause decarboxylation of at least a portion of the acid form cannabinoids into non-acid form cannabinoids to form an orally consumable beverage. The biomass is preferably dry powdered flower of Cannabis sativa L. in one embodiment of the invention.

The catalyst is any useful catalyst that enables decarboxylation. Preferably, the catalyst is selected from the group consisting of citric acid, ascorbic acid, citrus extract powder, citrus extract liquid, an amino acid, a Lewis Acid, and combinations thereof. Additional co-catalysts can be used.

In one embodiment, the step of providing dried Cannabis sativa L, includes providing a superfood powder including the catalyst with the Cannabis sativa L, which is in the form of a dried powder, and packaging the superfood powder together with dried Cannabis sativa L. for later use in a beverage.

The dried food powder can be blend food ingredients including ingredients selected from the group consisting of Barley Grass Juice, Nettle Leaf, Nopal Cactus, Spinach, Kale, Cabbage, Parsley, Spirulina, Mango, Banana, Chlorella, Maca Root, Mushroom Blend, Super Sprouts, Papaya, Sweet Mesquite, Fine Vanilla Bean, Lucuma Fruit, Goji Berry, Hawthorn Berry, Blackberry, Pomegranate, Blueberry, Acai, Strawberry, Tart Cherry, Cranberry, Red Raspberry, Vermont Maple Syrup, Lactobacillus sporogenes, digestive enzymes, Himalayan Pink Crystal Salt, Kelp, and combinations thereof.

The digestive enzymes mentioned above can include proteases, lipases and amylases found in natural plant biomass, or isolated enzymes. For example, in one embodiment of the invention the digestive enzymes include bromelain derived from pineapple. In another embodiment of the invention, the digestive enzyme includes papain derived from Papaya, amylase derived from mango, amylases and glucosidases derived from banana, catalase and oxidase enzymes derived from Bacillus and its metabolites. These digestive enzymes together, or some individually can be considered a co-enzyme to facilitate the decarboxylation reactions of the invention.

In other embodiments, the food ingredients include Lactobacillus sporogenes.

Preferably, the dried food powder to dried Cannabis sativa L is between 100:1 and 25:1 on a w:w basis. The dried Cannabis sativa L includes volatile terpenes and it is blended into the dried food powder at a temperature of less than 100° F. to preserve the volatile terpenes while enabling cold decarboxylation of cannabinoids when an aqueous solution is mixed with the dried Cannabis sativa L and the dried food powder.

In one embodiment, the primary is 0.01-1% of the composition on a w:w basis.

The composition of the present invention is intended to be packaged dry and sold to consumers that hydrate the composition and consume it orally as a beverage without heating. It can be appreciated that the composition can likewise be utilized as a food ingredient and cooked or eaten raw.

When used in a beverage the composition of the present invention is added to an aqueous solution is selected from the group consisting of juice, cow milk, blended fruit, water, nut milk, seed milk, or any combination thereof.

An alternate method of the present invention includes cold decarboxylation of acid form cannabinoids. The method includes providing dried Cannabis sativa L. biomass having acid form cannabinoids and forming a cannabinoid composition by mixing a catalyst with the Cannabis sativa L. biomass at a temperature of less than 176° F. to enable decarboxylation of at least a portion of the acid form cannabinoids into non-acid form cannabinoids upon the addition of an aqueous solution to the cannabinoid composition.

The catalyst is selected from the group consisting compounds found in food power selected from the group consisting of cations of metals, ions such as Mg²⁺ and Li⁺, carbocations, or other common cations of metals that can form coordination compounds in water, where water acts as the ligand, and combinations thereof. The catalyst can be a Lewis Acid.

In accord with another embodiment of the invention, includes an amino group, derived from a plant based L-amino acid derived from an amino acid selected from the group consisting of Arginine, Carnitine, Glutamine, Methionine, Ornithine, Taurine, and combinations thereof.

Alternatively, to the use of a catalyst to improve bio-effects of cannabinoids, the present invention includes providing a cytochrome p-450 enzyme inhibitor to inhibit first pass metabolism of the orally consumed cannabinoids. The necessity of decarboxylation is this minimized. It can be appreciated that the use of the enzyme inhibitor can be used in conjunction with the catalyst reaction to further improve bio-effects of cannabinoids.

In embodiments, the composition comprises a pharmaceutical product; the dosage forms described herein provide clear separation from the confusion associated with traditional preparations of natural cannabinoid products.

Any alterations and further modifications of the compositions and/or formulations described herein, which would normally occur to one skilled in the relevant art and having possession of this disclosure, are to be considered within the scope of the instant claims.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

What is claimed is:

1. A method for cold decarboxylation of acid form cannabinoids, comprising:
a. providing dried Cannabis sativa L. biomass having acid form cannabinoids;
b. forming a cannabinoid composition by mixing a catalyst with the Cannabis sativa L. biomass in an aqueous solution at a temperature of less than 176° F. to cause decarboxylation of at least a portion of the acid form cannabinoids into non-acid form cannabinoids to form an orally consumable beverage; and
c. the catalyst is selected from the group consisting of citric acid, ascorbic acid, citrus extract powder, citrus extract liquid, an amino acid, a Lewis Acid, and combinations thereof.

2. The method as set forth in claim 1, wherein the step of providing dried Cannabis sativa L, includes providing a superfood powder including the catalyst with the Cannabis sativa L, which is in the form of a dried powder, and packaging the superfood powder together with dried Cannabis sativa L. for later use in a beverage.

3. The method as set forth in claim 1, wherein the dried food powder is a blend of food ingredients including ingredients selected from the group consisting of Barley Grass Juice, Nettle Leaf, Nopal Cactus, Spinach, Kale, Cabbage, Parsley, Spirulina, Mango, Banana, Chlorella, Maca Root, Mushroom Blend, Super Sprouts, Papaya, Sweet Mesquite, Fine Vanilla Bean, Lucuma Fruit, Goji Berry, Hawthorn Berry, Blackberry, Pomegranate, Blueberry, Acai, Strawberry, Tart Cherry, Cranberry, Red Raspberry, Vermont Maple Syrup, Lactobacillus sporogenes, digestive enzymes, Himalayan Pink Crystal Salt, Kelp, and combinations thereof.

4. The method as set forth in claim 3, wherein the digestive enzymes include proteases, lipases and amylases.

5. The method as set forth in claim 3, wherein the digestive enzymes includes bromelain derived from pineapple.

6. The method as set forth in claim 3, wherein the digestive enzymes includes papain derived from Papaya.

7. The method as set forth in claim 3, wherein the digestive enzymes includes amylase derived from mango.

8. The method as set forth in claim 3, wherein the digestive enzymes includes amylases and glucosidases derived from banana.

9. The method as set forth in claim 3, wherein the food ingredients include Bacillus and its various metabolites including catalase and oxidase enzymes.

10. The method as set forth in claim 3, wherein the food ingredients include Lactobacillus sporogenes.

11. The method as set forth in claim 1, wherein the ratio of the dried food powder to dried Cannabis sativa L is between 100:1 and 25:1 on a w:w basis.

12. The method as set forth in claim 1, wherein the dried Cannabis sativa L includes volatile terpenes and it is blended into the dried food powder at a temperature of less than 100° F. to preserve the volatile terpenes while enabling cold decarboxylation of cannabinoids when an aqueous solution is mixed with the dried Cannabis sativa L and the dried food powder.

13. The method as set forth in claim 1, wherein the catalyst is 0.01-1% of the composition on a w:w basis.

14. The method as set forth in claim 1, wherein the composition is consumed orally without heating.

15. The method as set forth in claim 1, wherein the aqueous solution is selected from the group consisting of juice, cow milk, blended fruit, water, nut milk, seed milk, or any combination thereof.

16. A method for cold decarboxylation of acid form cannabinoids, comprising:
providing dried Cannabis sativa L. biomass having acid form cannabinoids;
forming a cannabinoid composition by mixing a catalyst with the Cannabis sativa L. biomass at a temperature of less than 176° F. to enable decarboxylation of at least a portion of the acid form cannabinoids into non-acid form cannabinoids upon the addition of an aqueous solution to the cannabinoid composition.

17. The method as set forth in claim 16, wherein the catalyst is selected from the group consisting compounds found in food power selected from the group consisting of cations of metals, H⁺ ions such as Mg²⁺ and Li⁺, carbocations, or other common cations of metals that can form coordination compounds in water, where water acts as the ligand, and combinations thereof.

18. The method as set forth in claim 16, wherein the catalyst is a Lewis Acid.

19. The method as set forth in claim 16, wherein the catalyst includes an amino group, derived from a plant based L-amino acid derived from an amino acid selected from the group consisting of Arginine, Carnitine, Glutamine, Methionine, Ornithine, Taurine, and combinations thereof.

20. The method as set forth in claim 19, further comprising providing a cytochrome p-450 enzyme inhibitor to inhibit first pass metabolism of the orally consumed cannabinoids.
